(19) United States
(12) Patent Application Publication
(10) Pub. No.: US 2020/0090108 A1
(43) Pub. Date: Mar. 19, 2020

(54) ACTIONABLE TASKS

(71) Applicant: ServiceNow, Inc., Santa Clara, CA (US)

(72) Inventors: Sanjay Kumar Gupta, Saratoga, CA (US); Rahul Guha, San Jose, CA (US); Harish Kumar Balachandra Bellamane, San Jose, CA (US); Yingjie Sun, San Jose, CA (US); Evan Ross Lipton, San Jose, CA (US)

(21) Appl. No.: 16/133,474

(22) Filed: Sep. 17, 2018

(51) Int. Cl. G06Q 10/06; G06F 17/30

(52) U.S. Cl. CPC G06Q 10/063118; G06F 17/30528

(57) ABSTRACT

A visual task management board may include multiple task records that includes information associated with the respective task records. The task records may include an action status field that displays if the task is actionable or is blocked. Further, if the task is blocked, the visual task management board may display why the action is blocked. Additionally, information associated with blocking of the task may be stored. If a task is not blocked, the visual task management board may display if the task needs attention, indicative that acting upon the task is urgent. The action status of a task may be based at least in part on action taken by a user of the visual task management board, such as via an action performed on the visual task management board.

### BACKGROUND

The present disclosure relates generally to task management, and more specifically, to improved organization of tasks on a visual task management board.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g., computing devices, load balancers, firewalls, switches, etc.) and software resources (e.g., productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In modern communication networks, examples of cloud computing services a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for users to develop, modify, and/or customize applications and/or automating enterprise operations without maintaining network infrastructure and/or allocating computing resources normally associated with these functions.

Cloud-based applications may be implemented using virtual server instances accessible via a public or private cloud network (which may be colloquially referenced as instances) and may include one or more aspects of task management. The tasks may be displayed on a visual task management board for the user to view information associated with the tasks. In some cases, a task on the visual task management board may be blocked due to a prerequisite for performing the task not having been met. In other words, the user may not be able to perform actions related to the task due to other actions (by the same user or other users) being pending. Such occurrences may lead to information displayed on the task board being misleading or incorrect.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed subject matter relates to display and organization of tasks on a visual task management board. The visual task management board may display multiple task records assigned to a particular user, such as based upon the user being logged into a client instance of a cloud platform. Each task record may include different task fields that each includes information associated with the respective task records. The task fields may include an action status field that displays if the task is actionable or blocked to enable the user of the visual task management board to determine if a task may be acted upon. Further, if the task is blocked, the action status field may display why the action is blocked. In some situations, a task may be blocked for multiple reasons, some or all of which may be displayed. Information associated with blocking of the task may also be stored. The action status field may also display if the task needs attention, which may further indicate an urgency of a task. The action status field may be based at least in part on action taken by the user, such as via an action performed via the visual task management board. For example, the user may submit that more information is desired, which may adjust the action status of the task to be blocked, and the adjusted action status may be reflected on the visual task management board. Therefore, the visual task management board enables the user to determine which tasks to act upon in an efficient manner.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram of an embodiment in which a virtual server supports and enables the client instance, in accordance with aspects of the present disclosure;

FIG. 5 depicts a visual task management board that may be used to organize tasks, in accordance with aspects of the present disclosure;

FIG. 6 is an embodiment of a method to associate a blocking task record to a task in response to triggering a blocking rule, in accordance with aspects of the present disclosure;

FIG. 7 is an embodiment of a method to remove a blocking task record from a task in response to triggering an unblocking rule, in accordance with aspects of the present disclosure;

FIG. 8 is an embodiment of a method for an adjustment of a needs attention status of a task, in accordance with aspects of the present disclosure;

FIG. 9 is an embodiment of a graphical user interface (GUI) that may be used to submit that a task blocked by a customer, in accordance with aspects of the present disclosure;

FIG. 10 is an embodiment of a GUI that may be used to submit that a task is blocked internally, in accordance with aspects of the present disclosure;

FIG. 11 is an embodiment of a GUI that may be used to manage blocking records of a task, in accordance with aspects of the present disclosure;

FIG. 12 is an embodiment of a GUI that may be used for adjusting the needs attention status of a task, in accordance with aspects of the present disclosure; and

FIG. 13 is an embodiment of data tables that may be used by an application to organize tasks, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, a “task” refers to any action item (e.g., incident, problem) assigned to a user to act upon on behalf of a requesting entity (e.g., customer). As used herein, a “user” refers to any entity that may be responsible for acting on a task presented on a visual task management board or list, and may include a customer service agent, for example. As used herein, a “visual task management board” refers to a visual display of task-specific information (e.g., summary information). For example, a visual task management board may list tasks assigned to a particular user for the user to view, analyze, and/or interact with the information efficiently. The visual task management board may include one or more graphical user interfaces (GUIs) that the user may interact with. As used herein, a “GUI” may refer to any interface that includes visual indicators, such as icons, symbols, images, modules, and the like, which the user may interact with to perform an action associated with the task management functionality of the application.

Various application running in local and networked contexts, including cloud-based application instances, may be used to create tasks and to assign tasks to a user to be completed. Additionally, the user may use such an application to organize tasks, such as on a visual task management board. For example, in one implementation a cloud-based application may be implemented for customer service management (CSM) to facilitate a user (e.g., a customer service agent) performing a customer generated task. The visual task management board may enable the user to organize and/or visualize the tasks. In this manner, the user may more efficiently act on and/or complete the tasks. However, in some circumstances the user may not be able to complete a particular task until further information is received and/or other actions are completed. Thus, the task may be deemed a blocked task, or a task that is blocked from being acted upon by the user, to indicate the status of the task is blocked from being actionable. On the visual task management boards, blocked tasks may be labeled as such to enable the user to discern the tasks are not actionable, thereby enabling the user to efficiently determine which tasks on the visual task management board may be acted upon. The blocked task may be actionable and the blocked status may be removed when certain actions are performed to enable the task to be actionable to the user. When a task adjusts from being blocked to being actionable, the display of the task on the visual task management board may adjust to enable the user to determine the task may be acted upon.

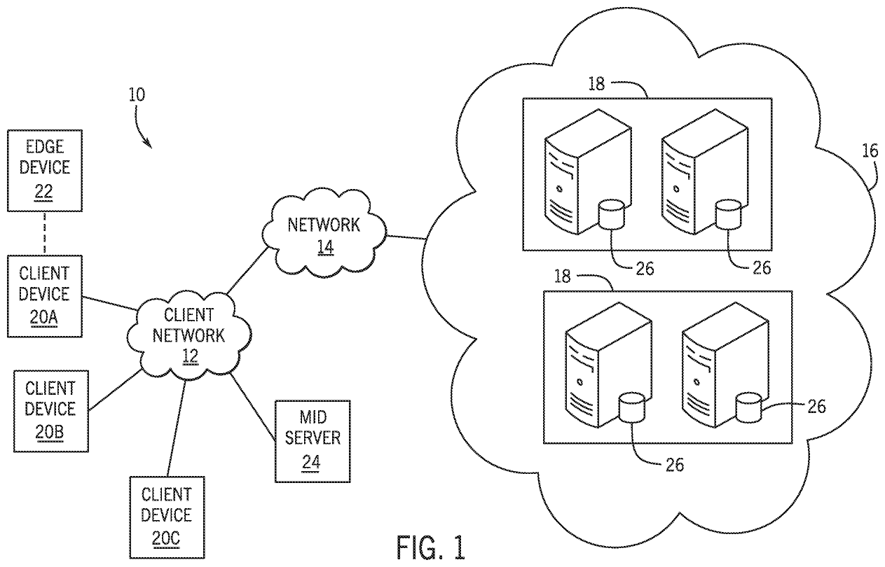

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, where embodiments of the present disclosure may operate, is illustrated. The computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

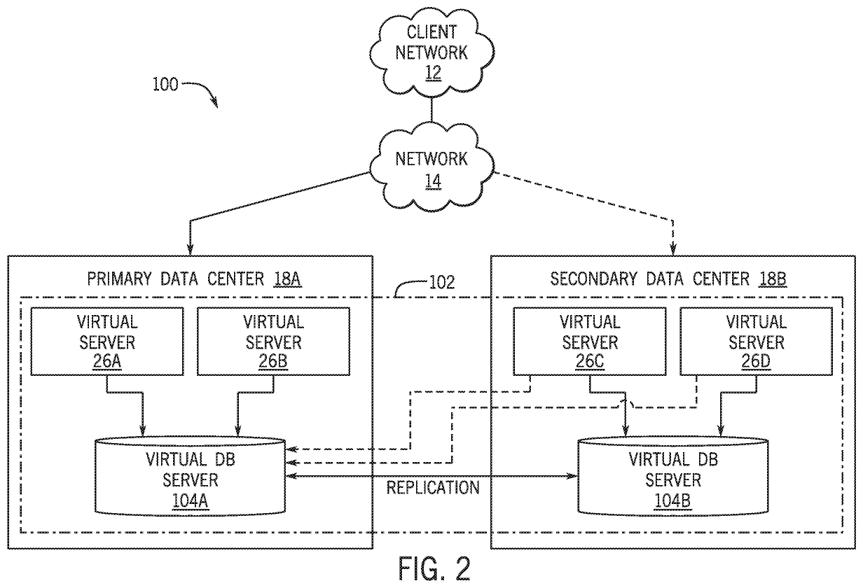

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers 26 (e.g., virtual servers 26A, 26B, 26C, and 26D) and dedicated database servers (e.g., virtual database servers 104A and 104B). Stated another way, the virtual servers 26A, 26B, 26C, 26D and virtual database servers 104A, 104B are not shared with other client instances but are specific to the respective client instance 102. Other embodiments of the multi-instance cloud architecture 100 could include other types of dedicated virtual servers, such as a web server. For example, the client instance 102 could be associated with (e.g., supported and enabled by) the dedicated virtual servers 26A, 26B, 26C, 26D, dedicated virtual database servers 104A, 104B, and additional dedicated virtual web servers (not shown in FIG. 2).

In the depicted example, to facilitate availability of the client instance 102, the virtual servers 26A, 26B, 26C, 26D and virtual database servers 104A, 104B are allocated to two different data centers 18A, 18B, where one of the data centers 18 acts as a backup data center 18. In reference to FIG. 2, data center 18A acts as a primary data center 18A that includes a primary pair of virtual servers 26A, 26B and the primary virtual database server 104A associated with the client instance 102, and data center 18B acts as a secondary data center 18B to back up the primary data center 18A for the client instance 102. To back up the primary data center 18A for the client instance 102, the secondary data center 18B includes a secondary pair of virtual servers 26C, 26D and a secondary virtual database server 104B. The primary virtual database server 104A is able to replicate data to the secondary virtual database server 104B (e.g., via the network 14).

As shown in FIG. 2, the primary virtual database server 104A may backup data to the secondary virtual database server 104B using a database replication operation. The replication of data between virtual database servers 104 could be implemented by performing full backups weekly and daily incremental backups in both data centers 18A, 18B. Having both a primary data center 18A and secondary data center 18B allows data traffic that typically travels to the primary data center 18A for the client instance 102 to be diverted to the second data center 18B during a failure and/or maintenance scenario. Using FIG. 2 as an example, if the virtual servers 26A, 26B and/or primary virtual database server 104A fails and/or is under maintenance, data traffic for client instances 102 can be diverted to the secondary virtual servers 26C, 26D and the secondary virtual database server instance 104B for processing.

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

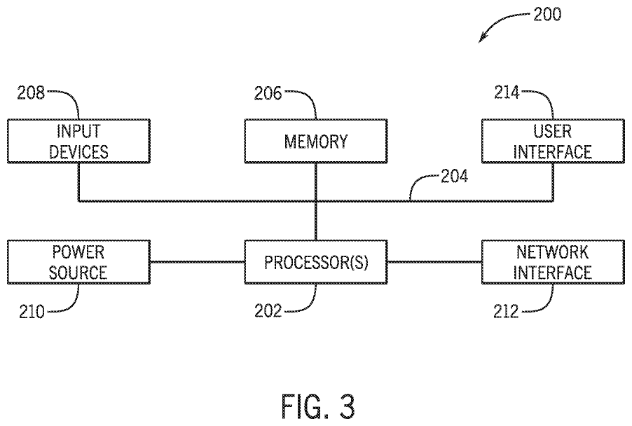

With this in mind, and by way of background, it may be appreciated that the present approach may be implemented using one or more processor-based systems such as shown in FIG. 3. Likewise, applications and/or databases utilized in the present approach stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3 may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard, and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

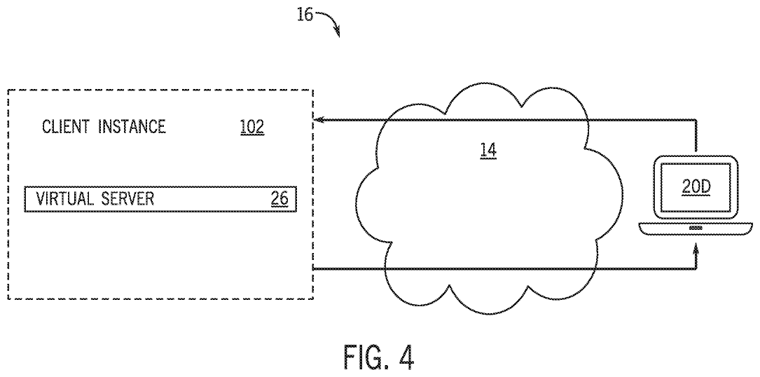

With the foregoing in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with a client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

The client instance 102 may be implemented to support access to a cloud-based application that, as part of its functionality, adjusts an action status of a task on a visual task management board. For example, the user may access a cloud-based application running on the cloud-based platform 16 via the client device 20, where the cloud-based application may, at least in part, organize tasks on a visual task management board.

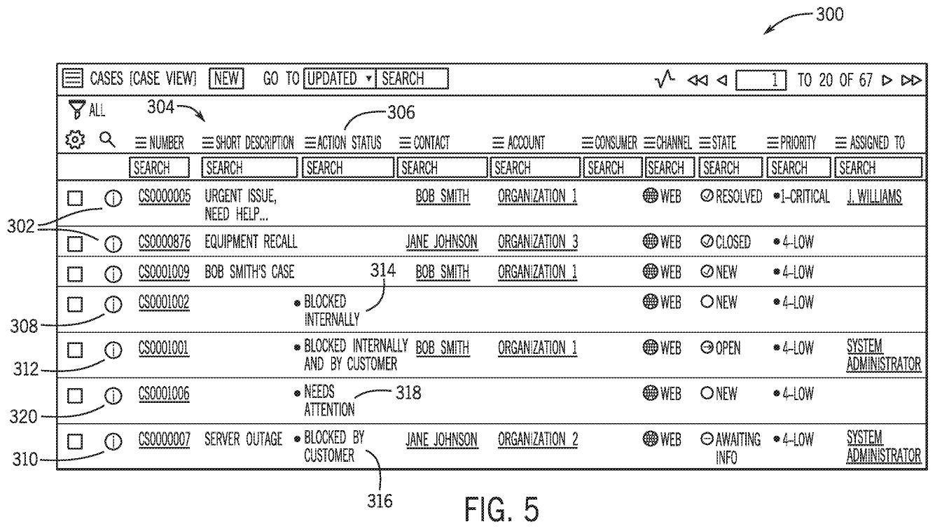

FIG. 5 is an embodiment of a visual task management board 300 that may be used to organize tasks. The visual task management board 300 includes rows, with each row corresponding to an assigned task 302. Each task 302 includes discrete elements of task information 304 (e.g., task number, description, status, and so forth) displayed in columns on the visual task management board 300. Each task 302 may be associated with a task record stored on a database, such as implemented or managed on the virtual database servers 106A and 106B, and may be generated as a result of a request by a customer, for example. In some embodiments, tasks 302 are assigned to specific users that are able to act upon the task 302, such as to complete the task for a customer. The virtual task management board 300 may display tasks 302 assigned to a particular user who is logged into a respective client device 20. In particular, the virtual task management board 300 may display the tasks 302 to enable the respective user to visualize, prioritize, organize, and/or complete tasks assigned to that user efficiently. As an example, the task information 304 may display information associated with each task 302 to enable the user to understand each task 302 quickly and determine whether or not to take action on the task 302. Although this disclosure primarily discusses a user performing actions associated with each task 302, it should be understood that in certain embodiments, the actions associated with each task 302 may be performed by other entities or groups of users (e.g., multiple users).

In certain embodiments, the task information 304 may include an action status 306 to facilitate the user in determining if a task 302 may currently be acted upon by the user. Specifically, the action status 306 may display if the corresponding task 302 is actionable (i.e., the user may currently act upon the task 302) or if the corresponding task 302 is blocked (i.e., the user cannot currently act upon the task 302). In the illustrated embodiment, a first task 308, a second task 310, and a third task 312 may each be blocked. Specifically, the action status 306 of the first task 308 may include a “blocked internally” label 314, the actions status 306 of the second task 310 may include a “blocked by customer” label 316, and the action status 306 of the third task 312 may include both the blocked internally label 314 and the blocked by customer label 316. In this manner, a user may be able to ascertain whether an action is blocked from being performed based upon an issue on the customer side), internal to the user's organization, or both.

For example, the blocked internally label 314, the blocked by customer label 316, or both may indicate that the task 302 is blocked until further action is performed by an entity other than the user (i.e., someone other than the current user needs to take an action before the user can act). In some embodiments, the blocked by customer label 316 may be indicative that the task 302 is blocked until further action is performed by the customer. For example, more information may need to be provided by the customer before any action may be performed on the task 302 by the user. The blocked internally label 314 is indicative that the task 302 is blocked and awaits further action to be performed by an internal entity (e.g., another user). As described herein, an internal entity may be an entity associated with the user (e.g., a member of the same organization as the user) and/or the cloud-based application (e.g., a member of technical services). For example, the user may desire to receive more information associated with the task 302. Thus, if the action status 306 of the task 302 displays both the blocked internally label 314 and the blocked by customer label 316, the user may desire further action to be performed by both the customer and an internal entity.

The blocked internally label 314 and the blocked by customer label 316 may be removed when the corresponding actions are completed as desired. That is, the blocked internally label 314 may be removed when the internal entity has acted upon the task 302 and the blocked by customer label 316 may be removed when the customer has acted upon the task 302. In certain embodiments, the blocked internally label 314 and/or the blocked by customer label 316 may be removed automatically. In other words, once it has been determined that the internal entity has acted upon the task 302, the blocked internally label 314 may be removed automatically. Likewise, once it has been determined that the customer has acted upon the task 302, the blocked by customer label 316 may be removed automatically. Additionally or alternatively, the blocked internally label 314 and/or the blocked by customer label 316 may be removed manually (e.g., by the user). In other words, the user may remove the blocked internally label 314 and/or the blocked by customer label 316 after the user has determined the actions performed by the internal entity and/or the customer adjusts the task 302 to be actionable.

In some embodiments, the action status 306 of the task 302 may also display a “needs attention” label 318, as indicated in a fourth task 320. In particular, the needs attention label 318 may indicate that an action by the user may currently be urgent and/or desirable. For example, the needs attention label 318 may be displayed in response to removal of the blocked internally label 314 and/or the blocked by customer label 316. In this manner, the needs attention label 318 indicates to the user that the task 302 has been updated to enable the user to act upon the task 302.

The action status 306 of the task 302 may also not be labeled (e.g., not labeled with the blocked internally label 314, the blocked by customer label 316, and/or the needs attention label 318). In some cases, an unlabeled action status 306 may indicate that the task 302 is actionable, but user action may not be as urgent as a task 302 that includes the needs attention label 318. In other words, a task 302 may generally be actionable if the action status 306 of the task 302 does not display the blocked internally label 314 or the blocked by customer label 316. However, the user may determine the urgency of acting upon the task 302 based on if the task 302 includes the needs attention label 318.

In general, the action status 306 of the respective tasks 302 may facilitate the user to determine which tasks 302 to act upon at the moment. For example, the blocked internally label 314 and/or the blocked by customer label 316 may enable the user to determine not to act upon the task 302. Additionally, the needs attention label 318 may enable the user to focus on the task 302. Thus, using the action status 306, the user may quickly determine which task 302 to act upon.

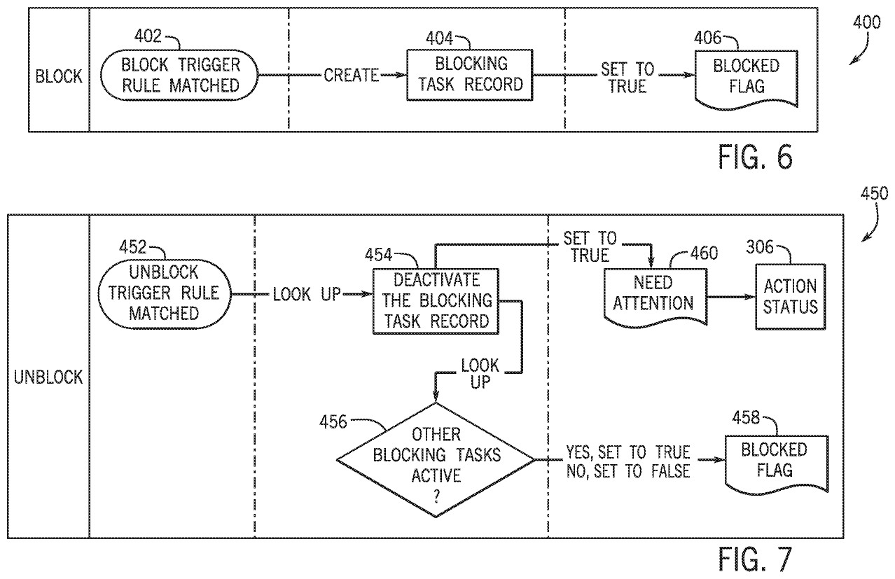

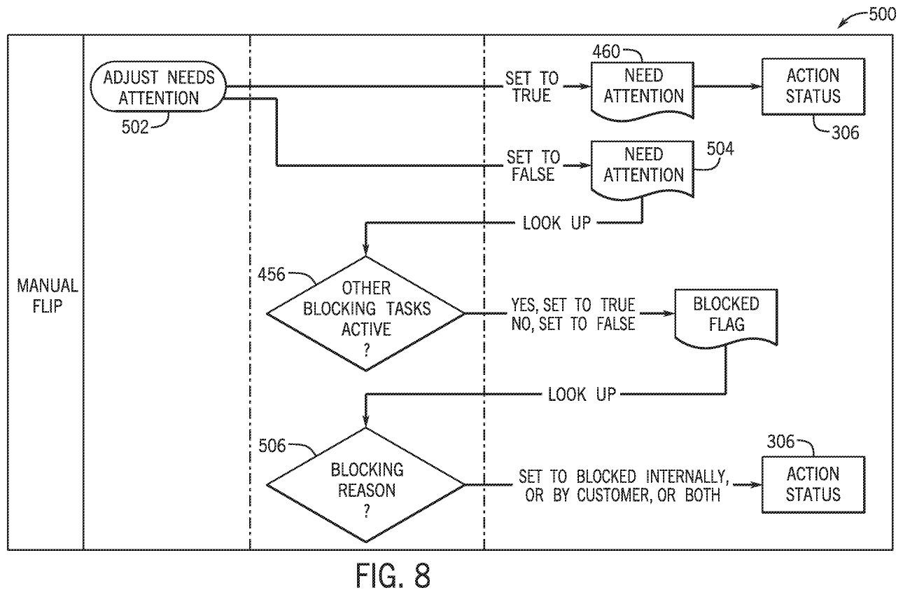

The following figures represent how the action status 306 of a task 302 may be adjusted. In particular, FIG. 6 illustrates how a blocking task record may be associated with a task 302 (e.g., with the blocked internally label 314 and/or the blocked by customer label 316), FIG. 7 illustrates how a blocking task record may be removed from being associated with a task 302, and FIG. 8 illustrates how the needs action label 318 may be added to or removed from a task 302. As used herein, a blocking task refers to any action performed on the task 302 that converts the task 302 to be blocked (i.e., not actionable), such as a submission by the user to request for more information from the customer, and a blocking task record refers to saved information associated with the blocking task. It should be appreciated that the respective steps of FIGS. 6-8 are not exclusive and additional steps not illustrated in FIGS. 6-8 may be performed. In general, the steps illustrated in FIGS. 6-8 may be performed via the cloud-based application as supported by the client instance 102.

FIG. 6 illustrates a flowchart of an embodiment of a method 400 for the action status 306 to display the blocked internally label 314 and/or the blocked by customer label 316. At step 402 of the method 400, the conditions specified by a blocking rule are matched or met. Different blocking rules may be associated with different blocking tasks, such as the type of blocking task (e.g., blocked internally or blocked by a customer). Thus, based on a submission by the user, a particular blocking rule may be matched. For example, the user may indicate that the user desires action to be performed by an internal entity and thus, the blocking rule associated with an internal blocking task may be activated or triggered.

Matching the blocking rule may cause a task record to be blocked, as indicated at step 404. Specifically, each task 302 may be updated to include blocking information associated with the blocking of the task 302. For example, each time a blocking rule is matched for a particular task 302, a corresponding task record may be updated to include the blocking information. In some embodiments, the record or entry may be updated to include which blocking rule was matched, when the blocking rule was matched, why the blocking rule was matched, and so forth. The blocking information of each task 302 may be viewable to the user to enable the user to view each blocking task record associated with the particular task 302.

After the blocking rule is matched and/or the task record is updated to include the blocking information, a flag may be set to as to display the task 302 as blocked on a visual task board, as shown at step 406. In particular, the action status 306 of the blocked task 302 may include the blocked internally label 314 and/or the blocked by customer label 316 based on the particular blocking rule that is active. In this manner, the user may view on the visual task management board 300 that the task 302 is blocked to determine the task 302 is not actionable and the user may view what particular blocking task is blocking the task 302.

FIG. 7 illustrates a flowchart of an embodiment of a method 450 for the blocked internally label 314 and/or the blocked by customer label 316 to be removed from display in the action status 306. At step 452, an unblocking rule is matched or triggered. The unblocking rule may be matched by an action performed by the user (e.g., the user indicates a blocking label is to be removed) or by an action performed by an internal entity and/or a customer (e.g., the internal entity and/or the customer sends information).

As a result of matching the unblocking rule, the corresponding task record implicated by the triggering of the unblocking rule may be updated to remove from the blocking status from the task 302, as indicated at step 454. That is, the unblocking rule may pertain to a particular task record for which a blocking status is currently active and the particular blocking status may be removed from the record. Other remaining blocking statuses may still apply to the task record, however.

After the particular blocking status is removed from the task record, it may be determined if there are other blocking statuses in the task record, as indicated at step 456. In other words, the task 302 may be blocked by other blocking conditions in addition to the particular blocking task that was removed. Thus, it may be determined if there are other blocking conditions associated with the task 302 that would still block the task from being actionable.

If there are still other blocking conditions associated with the task 302, at step 458, the associated blocking labels (e.g., the blocked internally label 314 and/or the blocked by customer label 316) may remain as or be updated to be the action status 306. If there are no longer other blocking tasks associated with the task 302, at step 458, the associated blocked label may be removed. In one example, a task 302 may include multiple internal blocking tasks and multiple customer blocking tasks. If a customer blocking task is resolved, the action status 306 of the task 302 may still include the blocked internally label 314 and the blocked by customer label 316. In another example, a task 302 may include multiple internal blocking tasks and one customer blocking task. In this case, if the customer blocking task is resolved, the action status 306 of the task 302 may still include the blocked internally label 314, but the blocked by customer label 316 may be removed.

As mentioned, in certain embodiments, removal of one or more blocking labels may result in labeling the task 302 with the needs attention label 318. Thus, at step 460, the action status 306 of the task 302 includes the needs attention label 318. In particular embodiments, the action status 306 may simultaneously display the needs attention label 318, the blocked internally label 314, and/or the blocked by customer label 316. In this manner, the user may determine that the task 302 may be partially actionable as a result of an action performed by an internal entity and/or a customer, but the task 302 may still be blocked by other blocking tasks.

FIG. 8 illustrates a flowchart of an embodiment of a method 500 performed based on an adjustment of the needs attention status of the task 302. At step 502, it is determined that the needs attention status of the task 302 is to be adjusted. As discussed above, removal of a blocking task may automatically indicate that the task 302 needs attention. However, in additional or alternative embodiments, the user may manually indicate whether or not the task 302 needs attention.

In response to determining that the task 302 needs attention, step 460 is performed, as described in FIG. 7. Specifically, the action status 306 of the task 302 updates to include the needs attention label 318. To this end, performing the step 454 of FIG. 7 may trigger performing the step 502 of FIG. 8 to indicate that the task 302 needs attention.

In response to determining that the task 302 no longer needs attention, step 504 may be performed, where the needs attention label 318 may be removed from the action status 306. In some embodiments, a submission of a blocking task may automatically trigger step 504 to be performed. In other words, if the task 302 includes the needs attention label 318, but the user submits a blocking task (e.g., information is desired from the customer), the needs attention label 318 may be automatically removed in response to the submitted blocking task.

Upon removal of the needs attention label 318, step 456 may be performed to determine if the task 302 includes any remaining active blocking tasks. Based on step 456, the action status 306 may be updated to indicate the presence of active blocking tasks. For example, if no blocking tasks are determined to be present and the task 302 is indicated as no longer needing attention, the action status 306 of the task 302 may not display any labels. However, if blocking tasks are determined to be present, at step 506, the reason the task 302 is blocked is determined. For example, it may be determined if the task 302 is blocked internally, blocked by the customer, or both. In additional or alternative embodiments, a more specific blocking reason may be determined, such as information associated with what is desired from a customer. In any case, the action status 306 of the task 302 may include the associated blocking label as determined by the step 506.

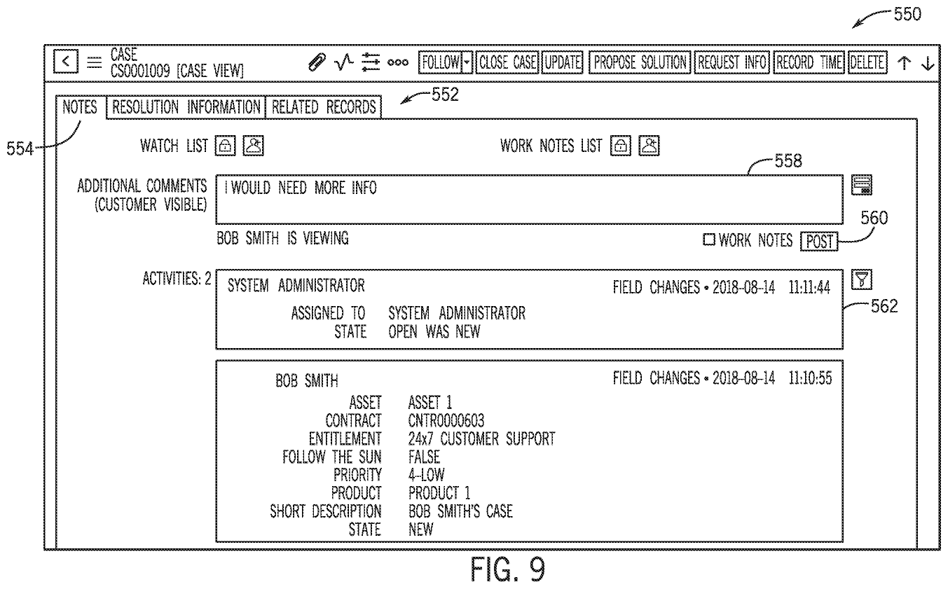

A user may initialize a cloud-based application to execute the method 400, the method 450, and/or the method 500. FIGS. 9-12 illustrate example GUIs that the user may use to indicate a task 302 is blocked and/or needs attention. In some embodiments, the cloud-based application used to display the visual task management board 300 may include the GUIs of FIGS. 9-12 or comparable interface and screens. To this end, the user may navigate the visual task management board 300 to indicate a task 302 is blocked and/or needs attention. For example, the GUIs of FIGS. 9-12 may be associated with a particular task 302 and the user may navigate to the respective GUIs by selecting the particular task 302 from the visual task management board 300.

FIG. 9 is an embodiment of a GUI 550 that the user may use to indicate that a task 302 is blocked by a customer and to view actions performed on the task 302. As depicted in FIG. 9, the GUI 550 includes tabs 552 and the GUI 550 may be displayed upon selection of a notes tab 554. In some embodiments, the GUI 550 may include a comments section 558 to enable a user to submit comments viewable by the customer. As an example, the user may indicate (e.g., text input) what is needed from the customer (e.g., description of information) to enable the user to act upon the task 302. Upon entering comments in the comments section 558, the user may select a submission icon 560 to submit the entered comments to the customer. Specifically, when the user selects the submission icon 560, the customer associated with the task 302 may receive a message or other indication of the comments entered by the user, which may correspond to a reason that action on the task is currently blocked. In other words, the customer associated with the task 302 may be notified of the user's submission and/or may view comments entered by the user via the comments section 558.

In additional or alternative embodiments, the GUI 550 may include an activities section 562 that displays the actions taken upon the task 302. For example, when a customer acts upon the task 302, an activity record or entry may be added to the activities section 562. Each activity record or entry may display information associated with the action taken upon the task 302, such as what the action was, when the action was performed, and so forth. Thus, the user may be able to view the activities section 562 to determine if the customer adequately took action as prompted by the user.

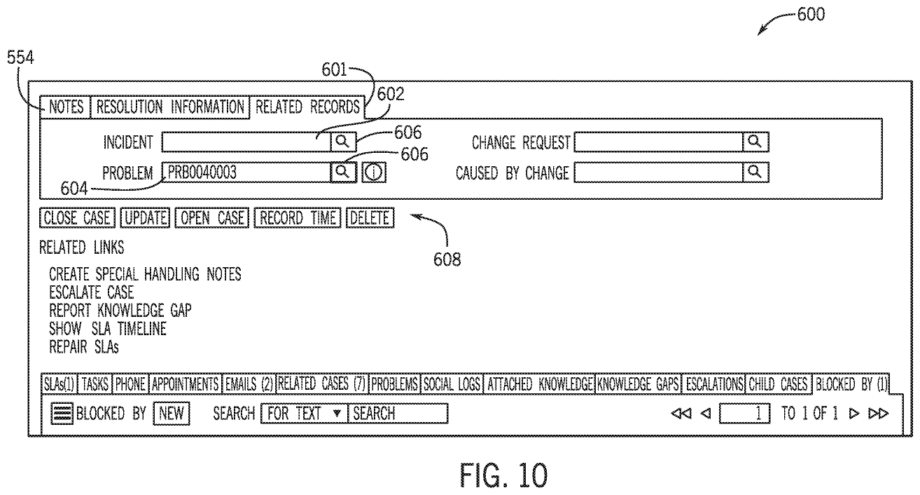

Another GUI may be used to indicate that a task 302 is blocked internally. FIG. 10 is an embodiment of a GUI 600 that may be displayed upon selection a related records tab 601. In the illustrated embodiment, the GUI 600 includes an incident section 602 and a problem section 604. The incident section 602 and the problem section 604 may, respectively, enable the user to indicate an incident (e.g., related to the task 302 as requested by the customer) and/or a problem (e.g., related to a reason the task 302 is blocked) associated with the task 302. An internal entity may receive the indicated incident and/or problem upon submission by the user that the task 302 is blocked internally.

In some embodiments, the user may be able to submit information associated with the incident and/or problem. That is, similar to the comments section 558, in the incident section 602 and/or the problem section 604, the user may submit information associated with the incident and/or problem, such as information regarding description of an issue, when the issue occurs, and the like. In additional or alternative embodiments, the user may be able to query the incident and/or problem. In other words, the user may select a query icon 606 to navigate to a list of possible incidents and/or problems (e.g., an identifier or code associated with a specific incident and/or problem), where the user may select a particular incident and/or problem that may be associated with the task 302. The incident section 602 and the problem section 604 may each include a respective query icon 606 to query a respective incident and problem.

The GUI 600 may also include blocking information icons 608 that may be selected to modify the user's indication of an internal blocking task. By way of example, the blocking information icons 608 may include an icon to enable the user to record a time of submission, an icon to enable the user to add more information (e.g., description) to the submission, an icon to enable the user to designate a member to send the submission, an icon to enable the user to submit the incident and/or problem and so forth. After a user submits the incident and/or problem, an internal entity (e.g., a task manager) may receive the submission and associated information of the submission. The internal entity may then view the submission and the associated information to act upon the task 302.

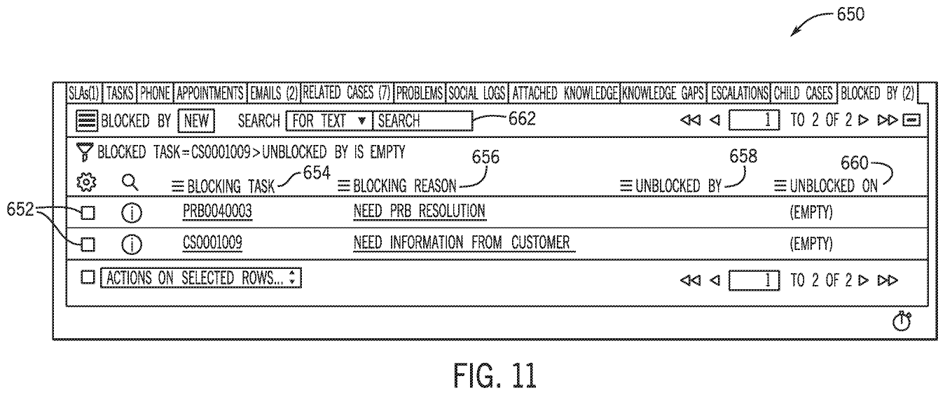

In particular embodiments, each blocking task submitted by the user may be logged. That is, each submission by the user indicating the task 302 is being blocked (e.g., via the GUI 550 and/or the GUI 600) may generate a blocking task record or entry. FIG. 11 is an embodiment of a GUI 650 that the user may use to view and/or manage each blocking task record or entry. The GUI 650 may display all blocking task records or entries, including all active and inactive blocking task records or entries. In the illustrated embodiment, each blocking task record 652 may include a blocking task field 654, a blocking reason field 656, an unblocked by field 658, and/or an unblocked on field 660. The blocking task field 654 may indicate the type of blocking task of the respective blocking task record or entry. For example, the blocking task field 654 may indicate if the blocking task is associated with a customer, an incident, and/or a problem. The blocking reason field 656 may include information regarding the particular blocking task, such as information (e.g., description) submitted by the user associated with the blocking task. The unblocked by field 658 may indicate which member, if any, performed an action on the task 302 that resulted in the blocking task record 652 no longer being active. As an example, the unblocked by field 658 may display a customer and/or a specific internal entity. The unblocked on field 660 may display a time, if any, that the blocking task record 652 is no longer active. That is, the unblocked on field 660 may display a day, month, year, or other information associated with the time when an action was performed in the task 302 and/or the time when the blocking task record 652 becomes inactive. If the task 302 has not become unblocked, that is, if the blocking task record remains active, the unblocked by field 658 and/or the unblocked on field 660 may remain empty. Thus, the user may determine which blocking task records 652 may still be actively blocking the task 302 based on the entries in the unblocked by field 658 and/or the unblocked on field 660.

The user may be able to organize the blocking task records 652 on the GUI 650. For example, the user may organize the blocking task records 652 based on the blocking task field 654 (e.g., alphabetically), the blocking reason field 656, the unblocked by field 658, and/or the unblocked on field 660 (e.g., from oldest to newest). In this manner, the user may better view the blocking task records 652 to determine what may be blocking the task 302. In some embodiments, the GUI 650 may include a blocking task query 662 that may enable the user to search for a particular blocking task record 652. For example, the user may input a blocking task type in the blocking task query 662 to determine if and/or how many of the blocking task records 652 includes the inputted blocking task type.

In certain embodiments of the GUI 650, the user may modify blocking task records 652. By way of example, the user may select a particular blocking task record 652 displayed on the GUI 650. When the user selects the particular blocking task record 652, the user may modify information associated with the particular blocking task record 652 (e.g., information associated with comments section 558 and/or an identifier for the incident or problem). The user may also be able to delete certain blocking task records 652. When the user modifies the blocking task record 652, the modification may update the member associated with the blocking task record 652 (e.g., the customer and/or the internal entity) to enable the member to take action based on the modification. In particular embodiments, the user may use the GUI 650 to manually indicate the status of a particular blocking task record 652. In other words, the user may adjust a blocking task from being active to inactive or from inactive to active. In this manner, the user may be able to adjust the status of the task 302 from blocked to actionable or from actionable to blocked.

It should be understood that the respective blocking task records 652 associated with each task 302 may be stored on a database that may be associated with the visual task management board 300. In some embodiments, a member (e.g., a task manager) may be able to view submitted blocking task records 652 of all tasks 302. In this manner, the member may determine information associated with the blocking task records 652, such as which incident and/or problem may be causing blocking task records 652 to be submitted. The member may use the information to hinder future tasks 302 from becoming blocked, such as by remedying commonly occurring incidents and/or problems.

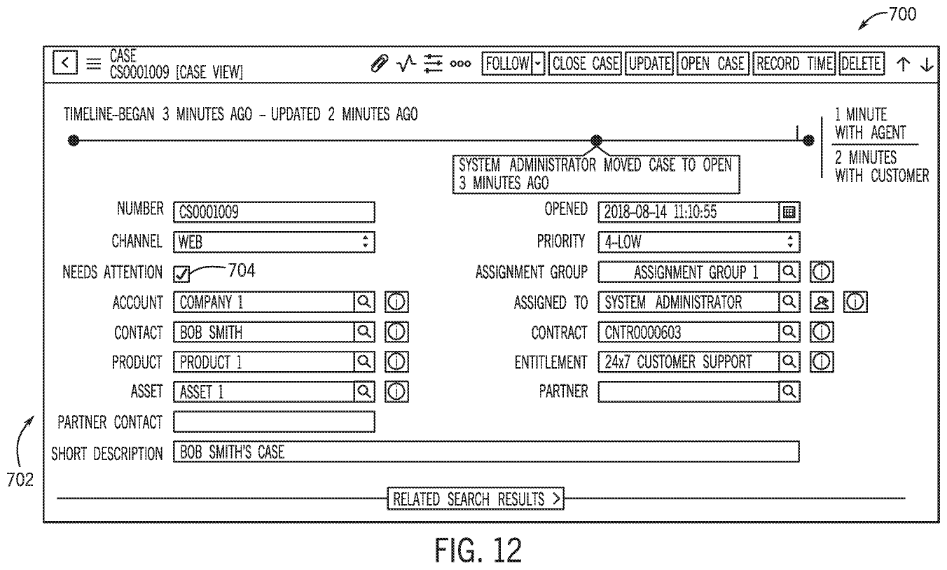

FIG. 12 illustrates a GUI 700 that may be used to indicate if a task 302 needs attention. In the illustrated embodiment, the GUI 700 includes multiple task information icons 702. As an example, the task information icons 702 may include general information associated with the task 302, such as when the task 302 was created, which user the task 302 is assigned to, an identifying code associated with the task 302, or any combination thereof. Certain task information icons 702 may be adjustable by the user to enable the user to modify particular task information associated with the task 302. The task information icons 702 may include a needs attention icon 704 that may be selectable by the user. For example, the needs attention icon 704 may be a checkbox that the user may select to check (i.e., indicating the task 302 needs attention) and/or uncheck (i.e., indicating the task 302 does not need attention). The user may use the needs attention icon 704 to indicate if the task needs or does not need attention (i.e., to include the needs attention label 318 in the action status 306). As previously described, using the needs attention icon 704 may trigger step 502 of FIG. 8 to be performed to adjust the actions status 306 of the task 302.

In some embodiments, the needs attention icon 704 may be used to designate further information associated with the task 302 needing attention. For example, the user may use the needs attention icon 704 to designate when the task 302 needs attention and/or why the task 302 needs attention. Thus, the user may use the GUI 700 to indicate details regarding the task 302 regarding the needs attention label 318.

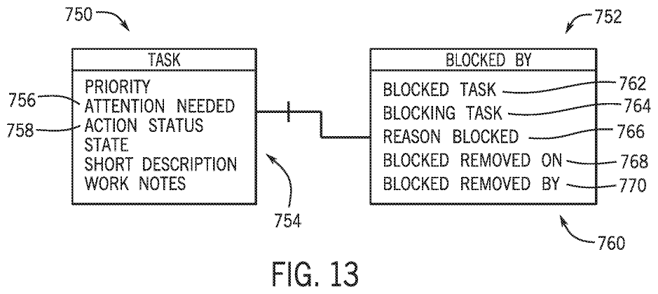

FIG. 13 illustrates examples of database tables that may be stored on the platform 16 and employed to implement the approach discussed above. In general, a cloud-based application accessed by one or more client devices 20) may access and use the database tables to organize tasks. For example, the database may include a task table 750 that stores task records and has fields associated with each task record. Certain task record fields may in turn reference blocking states stored in the “blocked by” table 752, which stores records containing fields associated with blocking data that may be referenced by the task records in a one to one or one to many manner (i.e., a task record may reference more than one blocking record).

Thus, as shown herein, the task table 750, for example, may include task fields 754, where each task field 754 may correspond to particular task information 304 displayed on the visual task management board 300 for each task record. Each task field 754 may include a value, or the particular information associated with the task field 754. By way of example, the task fields 754 may include an attention needed field 756 and/or an action status field 758. The task fields 754 may also include additional fields, such as fields associated with an identifier, a priority, a description, a contact, an account, and/or an assigned user of the particular task 302. In any case, each task field 754 may include an assigned value, where the assigned value may be displayed on the visual task management board 300. Based on the value within the attention needed field 756, the visual task management board 300 may display the attention needed label 318. Similarly, based on the value within the action status field 758, the visual task management board 300 may display a corresponding blocked internally label 314 and/or blocked by customer label 316.

In certain embodiments, the action needed field 756 and/or the action status field 758 may be determined by information associated with the blocking table 752. Specifically, the blocking table 752 may include fields 760, where the value of the attention needed field 756 and/or the value of the action status field 758 may be based at least in part on the respective values within the respective fields 760 referred to by a respective task record. For example, the fields 760 may include a blocked task field 762 and/or a blocking task field 764. The blocked task field 762 may indicate whether or not the task 302 is blocked and the blocking task field 764 may indicate the type of blocking task (e.g., blocked internally or blocked by customer). Thus, the value associated with the action status field 758 may be based on the blocked task field 762 and/or the blocking task field 764 to determine the corresponding label to be displayed on the visual task management board 300.

The fields 760 may additionally include a reason blocked field 766, a blocked removed on field 768, and/or a blocked removed by field 770. The values associated with the reason blocked field 766, the blocked removed on field 768, and/or the blocked removed by field 770 may determine other values associated with the task table 750. In a particular example, the GUI 650 may use the task table 750 to display information in the blocking reason field 656, the unblocked by field 658, and/or the unblocked on field 660. Specifically, information in the blocking reason field 656 may be determined by the value in the reason blocked field 766, information in the unblocked by field 658 may be determined by the value in the blocked removed on field 768, and information in the unblocked on field 660 may be determined by the value in the blocked removed by field 770.

Moreover, the attention needed field 756 may also be based on the respective values associated with the blocked task field 762 and/or the blocking task field 764, such as a change in the blocked task field 762. Specifically, a change in the value of the blocked task field 762 from blocked to unblocked may trigger step 454 of FIG. 7. Thus, the attention needed field 756 may be activated to display the attention needed label 318 on the visual task management board 300.

The value of each field 760 may be based on information submitted by the user. In other words, when a user submits a blocking task, such as via the GUI 600 of FIG. 10 and/or the GUI 650 of FIG. 11, the information associated with the submission may determine the value in each of the fields 760.

The disclosed subject matter relates to an organization of tasks on a visual task management board. The visual task management board may include multiple task records assigned to a particular user. Each task record may include different task fields that each includes information associated with the respective task records. The task fields may include an action status field that displays if the task is actionable or blocked to enable a user of the visual task board to determine if a task may be acted upon. Further, if the task is blocked, the action status field may display why the action is blocked. Information associated with blocking of the task may also be stored. The action status field may also display if the task needs attention, indicative that acting upon the task is urgent. The action status field may be based at least in part on action taken by the user, such as via an action performed on the visual task management board. For example, the user may submit that more information is desired, which may adjust the action status of the task to be blocked, as may be reflected on the visual task management board. Therefore, the visual task management board enables the user to determine which tasks to act upon and to adjust the status of each task in an efficient manner.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(1). However, for any claims containing elements designated in any other manner, it is intended that such elements are not to be interpreted under 35 U.S.C. 112(f).

1. A system, comprising:
an application accessible via a client instance running; and
a database accessible by the client instance running, the database comprising:
a task table storing a plurality of task records, wherein each task record of the plurality of task records comprises at least an attention needed field and an action status field and wherein a task is associated with each task record of the plurality of task records; and
a blocking table defining a plurality of assignable values for at least the action status field based at least in part on an input via the application, wherein at least one assignable value of the plurality of assignable values corresponds to a task being blocked; and
wherein the application is configured to display the respective tasks associated with each record of the plurality of task records, wherein the application is configured to display an action status associated with each respective task based at least in part on the corresponding action status field, and wherein the action status is indicative of if the task is actionable or blocked.

2. The system of claim 1, wherein at least one other assignable value of the plurality of assignable values corresponds to a reason the task is being blocked, wherein the application displays the reason the task is being blocked.

3. The system of claim 2, wherein the reason the task is being blocked corresponds to being blocked internally, being blocked by a customer, or both.

4. The system of claim 1, wherein the input comprises a submission via the application, wherein the input is indicative that an action is to be performed such that the action status field is indicative that an associated task is blocked.

5. The system of claim 4, wherein the input comprises a submission that the action has been performed such that the action status field is indicative that the associated task is actionable.

6. The system of claim 1, wherein the blocking table defines an additional plurality of assignable values for the attention needed field, wherein at least one assignable value of the additional plurality of assignable values corresponds to the task needs attention.

7. The system of claim 6, wherein the assignable value of the attention needed field is based at least in part on the assignable value of the action status field.

8. The system of claim 1, wherein each task record of the plurality of task records comprises an identifier field, a priority field, a description field, a contact field, an account field, an assigned user field, or any combination thereof.

9. A system, comprising:
an application accessible by a client instance running; and
a database accessible by the client instance running, the database comprising:
a task table storing a plurality of task records, wherein each task record of the plurality of task records comprises at least an attention needed field and an action status field and wherein a task is associated with each task record of the plurality of task records; and
a blocking table storing a plurality of blocking records, wherein each blocking record of the plurality of blocking records comprises a plurality of blocking fields, wherein the plurality of blocking fields is configured to define a plurality of first assignable values for at least the action status field, and wherein the plurality of blocking fields is configured to define a plurality of second assignable values for at least the attention needed field; and
wherein the application is configured to display the respective tasks associated with each task record of the plurality of task records, wherein the application is configured to display an action status associated with each respective task based at least in part on the corresponding action status field and attention needed field.

10. The system of claim 9, wherein a first assignable value of the plurality of first assignable values, a second assignable value of the second assignable values, or both, is based at least in part on an input.

11. The system of claim 9, wherein the plurality of first assignable values comprises blocked internally, blocked by customer, or both.

12. The system of claim 9, wherein the blocking table comprises at least one blocking field indicative of a task being blocked, an action blocking the task, at least one blocking field indicative of a description of the action blocking the task, at least one blocking field indicative of when the task was unblocked, at least one blocking field indicative of how the task was unblocked, or any combination thereof.

13. The system of claim 9, wherein each blocking record of the plurality of blocking records is associated with a task record of the plurality of task records.

14. The system of claim 9, wherein the application is configured to display each blocking record of the plurality of blocking records.

15. The system of claim 14, wherein displaying each blocking record of the plurality of blocking records is based at least in part on at least the plurality of blocking fields.

16. A method, comprising:
determining, via a client instance, a matching of a rule to adjust a blocking record of a blocking table, wherein the blocking table defines a plurality of assignable task values of an action status field for a task record of a task table;
adjusting, via the client instance, the blocking record of the blocking table;
adjusting, via the client instance, the action status field based at least in part on adjusting the blocking record;
adjusting, via the client instance, an action status of a task associated with the task record based at least in part on adjusting the action status field; and
displaying, via the client instance, the action status of the task on a client device.

17. The method of claim 16, comprising adjusting an attention needed field of the task record in response to adjusting the action status field.

18. The method of claim 16, comprising receiving, via the client device, an input indicative of a blocking task, wherein determining the matching of the rule to adjust the blocking record of the blocking table is in response to receiving the input.

19. The method of claim 16, wherein adjusting the blocking record comprises adjusting a blocking field of the blocking record to correspond to the task record being blocked internally, blocked by customer, or both.

20. The method of claim 19, wherein adjusting the blocking record comprises adjusting the blocking field of the blocking record to correspond to the task record being unblocked.
